(19) United States
(12) Patent Application Publication
(10) Pub. No.: US 2010/0118112 A1
(43) Pub. Date: May 13, 2010

(54) GROUP TABLE TOP VIDEOCONFERENCING DEVICE

(75) Inventors: ALAIN NIMRI, Austin, TX (US); Anthony Martin Duys, Merrimac, MA (US); Brian A. Howell, Marblehead, MA (US); Gary R. Jacobsen, Salisbury, MA (US); Taylor Kew, Winchester, MA (US); Rich Leitermann, Arlington, MA (US); Kit Russell Morris, Austin, TX (US); Brad Philip Collins, Austin, TX (US); Nicholas Poteraki, Austin, TX (US); Hayes Urban, Austin, TX (US); Stephen Schaefer, Cedar Park, TX (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: POLYCOM, INc., Pleasanton, CA (US)

(21) Appl. No.: 12/270,338

(22) Filed: Nov. 13, 2008

(51) Int. Cl. H04N 7/15

(52) U.S. Cl. 348/14.08; 348/E07.083

(57) ABSTRACT

A group table top videoconferencing device for communication between local participants and one or more remote participants provides a camera assembly and display screens on the same housing—giving the remote participant the perception that the local participant is making direct eye-to-eye contact with him/her. The housing is placed such that the housing is within the field of view of every local participant viewing any other local participant. Because, the remote participant is always within the field of view of the local participant, the remote participant does not get the feeling of non-intimacy during the videoconference. A wall mounted display operates in conjunction with the videoconferencing device to display media content received from the remote participants. Keypad and a touch screen provide user interface for controlling the operation of the videoconferencing device. Speakers convert audio signals received from the remote participants into sound.

### FIELD OF THE INVENTION

The present invention relates generally to videoconferencing systems, and more particularly to group table top videoconferencing systems.

### BACKGROUND

Videoconferencing systems have become an increasingly popular and valuable business communications tool. These systems facilitate rich and natural communication between persons or groups of persons located remotely from each other, and reduce the need for expensive and time-consuming business travel.

Many commercially available videoconferencing systems have a video camera to capture the video images of the local participants and a display to view the video images of the remote participants. Typically the camera and the display are mounted at one end of the room in which the local participants are meeting. For example, FIG. 1 illustrates a setup where a videoconferencing device 105 that includes a camera 101 and a display 103 is placed at one end of the conference room. As shown in FIG. 1, the local participants 107, 109, 111, and 113 are conducting a meeting around a conference table 115. A videoconferencing device 105 is mounted at one end of the conference room. In the setup shown, at least one of the local participants is required to look towards the camera 101 and display 103 when communicating with the remote participants, and to look away from the camera 101 and display 103 when communicating with other local participants. For example, local participant 109, when talking with another local participant 107, is looking away from the videoconferencing device 105 and, essentially, the remote participant. In another example, when the local participant 111 is looking towards the videoconferencing device 105, he/she is looking away from all other local participants 107, 109, and 113. Each local participant has a field of view denoted by an angle a. For local participant 109, when talking to other local participant 107, the videoconferencing device 105 is out of its field of view. For local participant 111, when looking at the remote participant on the videoconferencing device 105, all the other local participants 107, 109, and 113 are out of its field of view. From the remote participant's perspective, no eye-contact is established with the local participant 109. The effective eye-contact field of view may be even less than that shown in FIG. 1. Therefore, when a local participant communicates with other local participants during a videoconference, the remote participants are given a feeling of being distant and non-intimate with the local participants. In other words, the remote participants may not feel as a part of the meeting.

In the example illustrated in FIG. 1, at least one local participant can have either the other local participants within its field of view, or the remote participant within its field of view, but not both. Therefore, the remote participants may not feel as being a part of the meeting. Similarly, the local participants may feel that the remote participants are not part of the meeting.

Therefore, it is desirable to have a videoconferencing device that mitigates the feeling that remote participants not being in the same meeting as the local participants.

### SUMMARY

A group table top videoconferencing device is disclosed that is adapted for real-time video, audio, and data communications between local and remote participants. The videoconferencing device can include a plurality of display screens for displaying media content received from the remote participants, one or more camera assemblies for capturing the video of local participants, speakers for converting audio signals from remote participants into sound, and microphone arrays for capturing the voice of local participants. The videoconferencing device can also include a retractable pole that can hide the camera assembly from the local participants when the camera is not in use. The retractable pole can be extended such that the camera assembly is at a sufficient height so as to clearly view the faces of the local participants that may be sitting behind laptop computers.

The camera and display screen can be disposed on the same housing, therefore the camera and the display screens can be in close proximity with each other. As a result, the eyes of the local participant need to move by an imperceptible small angle from directly viewing the camera to directly viewing the remote participant on the display screen—giving the remote participant the perception that the local participant is making direct eye-to-eye contact with him/her.

The videoconferencing device can be placed substantially at the center of the table where the local participants gather for a meeting. This allows the local participants to talk to other local participants and simultaneously gather, through his/her peripheral field of view, feedback from the remote participants being displayed on the display screen. Because, the remote participant is always within the field of view of the local participant, the remote participant does not get the feeling of non-intimacy during the videoconference.

The various embodiments of the group table top videoconferencing device disclosed herein can have a processing module including hardware and software to control the operation of the videoconferencing device. The processing module can communicate with camera controllers to control the orientation, tilt, pan, and zoom of each camera. The processing module can communicate with the microphone arrays to receive and process the voice signals of the local participants. In addition, the processing module can communicate with display screens, speakers, remote communication module, memory, general I/O, etc., required for the operation of the videoconferencing device.

The videoconferencing device can automatically detect the total number of local participants. Further, the videoconferencing device can automatically detect a monologue and the location of the local participant that is the source of the monologue. The processing module can subsequently reposition the camera to point and zoom towards that local participant that is the source of the monologue.

The videoconferencing device can automatically track the movement of the local participant in an image. The videoconferencing device may employ audio pickup devices or face recognition from an image to continuously track the movement of the local participant. The tracking information can be transformed into new orientation data for the cameras. Therefore, the remote participants always see the local participant in the center of the image despite the local participant's movements.

The videoconferencing device can also be used in conjunction with a wall mounted display. The wall mounted content display can display multimedia content from a laptop or personal computer of the participants. The videoconferencing device can also swap the contents displayed by the wall mounted content display and the display screens disposed on the housing.

The videoconferencing device can also include touch screen keypads on the display screen and mechanically removable keypads connected to the housing. The keypads can allow one ore more participants to control the function and operation of the videoconferencing device. These and other benefits and advantages of the invention will become more apparent upon reading the following Detailed Description with reference to the drawings.

### BRIEF DESCRIPTION OF THE DRAWINGS

Exemplary embodiments of the present invention will be more readily understood from reading the following description and by reference to the accompanying drawings, in which:

FIG. 1 illustrates the conventional positioning of a videoconferencing device with respect to local participants.

FIG. 2 illustrates a group table top videoconferencing device placed on a table.

FIG. 3 shows a group table top videoconferencing device having four display screens.

FIG. 4 shows a group table top videoconferencing device with four display screens in the shape of a hexahedral.

FIG. 5 shows the positioning of the group table top videoconferencing device.

FIG. 6 illustrates the group table top videoconferencing device of FIG. 2 with the camera assembly retracted.

FIG. 7 illustrates the group table top videoconferencing device of FIG. 3 with the camera assembly retracted.

FIG. 8 illustrates the group table top videoconferencing device of FIG. 4 with the camera assembly retracted.

FIG. 9 shows a block diagram of a group table top videoconferencing device.

FIG. 10 shows a flowchart of a method for determining the total number of local participants.

FIG. 11 shows a flowchart of a method for tracking the local participants with a camera.

FIG. 12 shows the group table top videoconferencing device used in conjunction with a wall display module.

FIG. 13 depicts a group table top videoconferencing device with a keypad controller.

FIG. 14 depicts a group table top videoconferencing device with a touch screen user interface.

### DETAILED DESCRIPTION

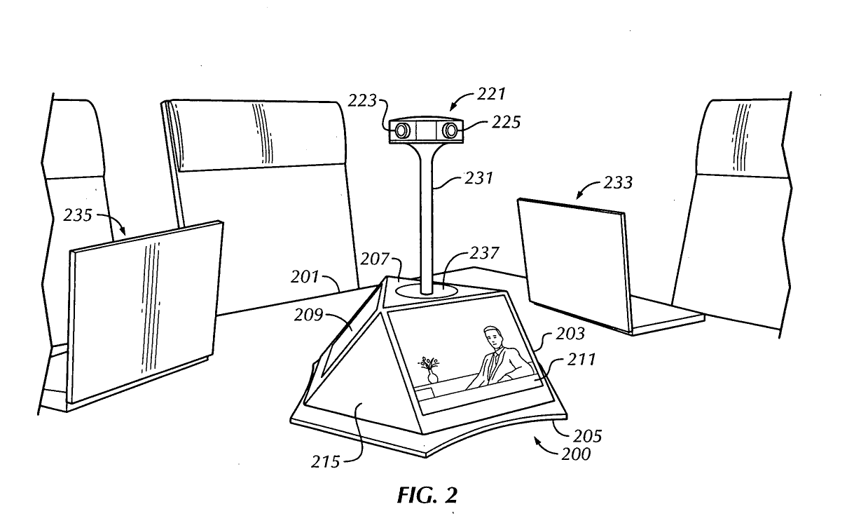

FIG. 2 shows a group table top videoconferencing device 200 that addresses various deficiencies of the prior art discussed above. A videoconferencing device 200 can be placed on a table 201 where the local participants (not shown) gather to conduct meetings among themselves and/or with remote participants via the videoconferencing device 200. As shown, the videoconferencing device 200 can include a housing 203 that encloses and protects the electronic components (not shown) of the videoconferencing device 200. The housing shown in FIG. 2 has a substantially hexagonal base 205; three rectangular and three triangular side surfaces; and a triangular top surface 207. Other arrangements are also possible.

The base 205 provides support and stability to the videoconferencing device 200. Three display screens 209-213 can be disposed on the three rectangular side surfaces of the housing 203. The display screens 209-213 can display media content received from remote participants. Speakers 215-219 can be disposed on the three triangular surfaces of the housing 203. The speakers 215-219 convert the audio signals received from the remote participants into sound.

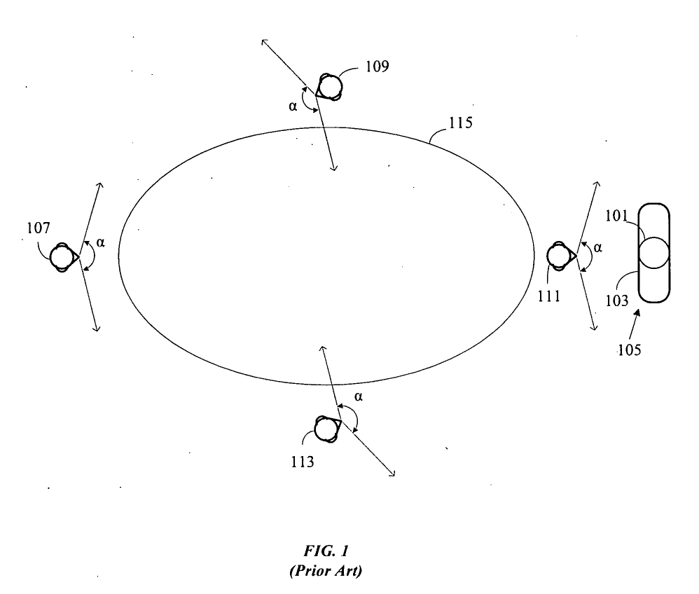

The videoconferencing device 200 can also include a camera assembly 221 that captures image and video content of the local participants. The camera assembly 221 can be capable of panning, tilting, and zooming. The camera assembly can include a plurality of (e.g., four) image pickup devices, or cameras, 223-229 (only cameras 223 and 225 are visible in FIG. 1) arranged such that, in combination, the four cameras cover a 360 degree view of the surroundings. The camera assembly 221 can be mounted on a retractable pole 231. The pole 231 can be extended to a height that enables the cameras 223-229 to capture the faces of the local participants possibly sitting behind the screens of laptops 233 and 235. A plurality of microphone arrays (not shown) can also be provided on the camera assembly 221. This allows for a mouth-to-microphone path that is unimpeded by the screens of the laptops 233 and 235. Alternatively, microphones can be positioned in any other suitable location.

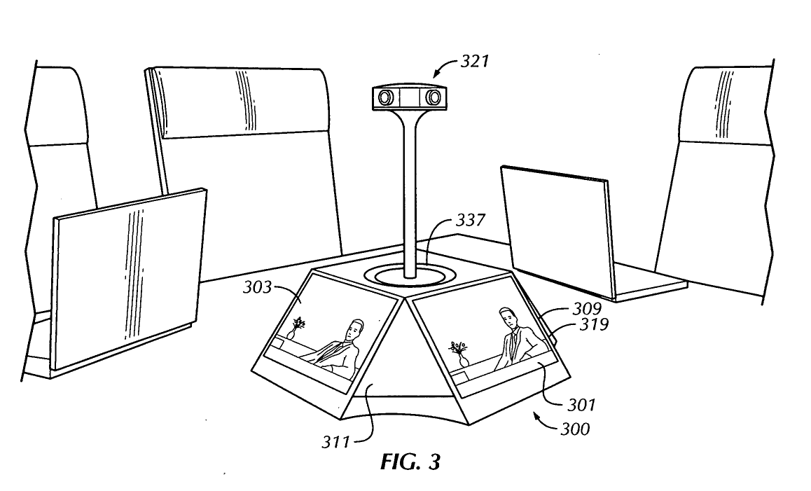

The number of display screens and the number of speakers are not limited to that shown in FIG. 2. FIG. 3 illustrates a videoconferencing device 300 having four display screens 301-307. As shown in FIG. 3, the housing 309 can include a substantially octagonal base, four rectangular side surfaces, and four triangular side surfaces. Display screens 301-307 can be located on the four rectangular side surfaces of the housing 309. Speakers 311-317 are disposed on the four triangular surfaces of the housing 309.

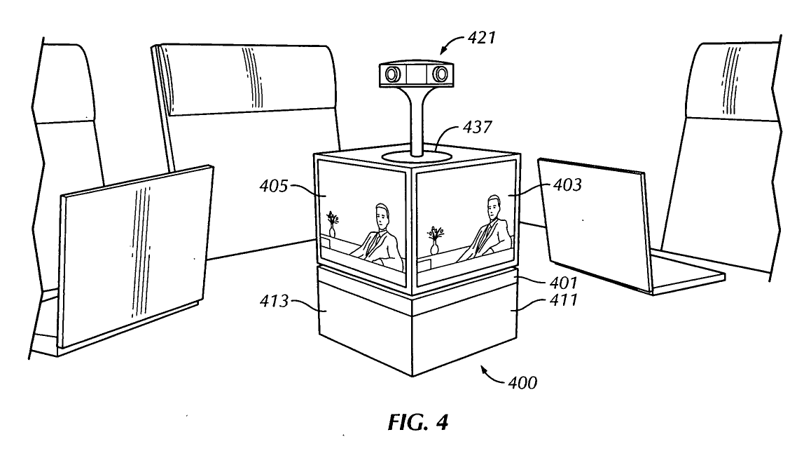

FIG. 4 depicts an alternative arrangement of a videoconferencing device 400 with four display screens. FIG. 4 shows a substantially hexahedral housing 401 with a rectangular base, rectangular top surface, and four rectangular side surfaces. Display screens 403-409 can be provided on the four rectangular side surfaces of the housing 401. FIG. 4 also shows speakers 411-417 disposed below each display screen 403-409.

In the exemplary videoconferencing devices illustrated in FIGS. 2-4, both the camera assembly and the displays are in close proximity with respect to each other. As a result, the angle formed by the display screen and the camera on the eye of a local participant is relatively small. In other words, the eyes of the local participant need to move by an imperceptibly small angle from directly viewing the camera to directly viewing the remote participant on the display screen. While communicating with the remote participant, it is natural for the local participant to talk while looking at the display screen where the video of the remote participant appears. Therefore, the local participant typically makes eye contact with the display screen, instead of making eye contact with the camera. However, the video or image received at the remote site results from the point of view of the camera. Because the angle formed on the eye by the camera and the display is relatively small, the remote participants get an enhanced perception that the local participant is making direct eye-to-eye contact with him/her.

The videoconferencing device can be placed on the table where the local participants gather to conduct the meeting. In such an embodiment, the videoconferencing device can be placed substantially in the center of the table, with the local participants sitting around the table. During an ongoing videoconference with remote participants, local participants look towards the videoconferencing device while talking to the remote participants, and look more directly at the local participants while talking to other local participants. Because of the arrangements described herein, the videoconferencing device is always within the field of view of the local participant even when the local participant is looking directly towards other local participants sitting around the table. As a result, the remote participant is less likely to feel disconnected from the local participants.

FIG. 5 illustrates a conferencing arrangement where the videoconferencing device is placed substantially at the center of the table. The videoconferencing device 500 can be operated by local participants 501, 503, 505, and 507 to communicate with one or more remote participants. FIG. 5 shows a top view of the videoconferencing device 500, including four display screens 509-515 and a camera assembly 517, disposed substantially centrally on the conference table 519. A field of view associated with each local participant is denoted by α. Typically the field of view is defined as the angular extent to which the surroundings are seen at any given time. For human vision, the field of view is typically in the range of 120° to 150°. In the examples illustrated in FIG. 1 and FIG. 5, the field of view of the local participants is assumed to be 150°. The field of view for human vision can be divided into two regions (a) the foveal field of view (FFOV) and (b) the peripheral field of view (PFOV). The FFOV is the portion of the field of view that falls upon the high-acuity foveal and macula lutea regions of the retina, while PFOV is the portion of the field of view that is incident on the remaining portion of the retina. When the eyes directly focus on an object, the region around the center of focus falls within the FFOV, and the remaining area falls within the PFOV. The FFOV includes approximately 2° of the center of the full field of view.

For example, with reference to the illustration in FIG. 5, when the local participant 503 focuses on another local participant, e.g. 501, the local participant 501 is within its FFOV, while the videoconferencing device 500 is within its PFOV. This allows the local participant 503 to talk to the other local participant 501 and simultaneously gather, through his/her PFOV, feedback from the remote participant displayed on the display screen 509. The reverse is also true when a local participant is talking to a remote participant. Additionally, because the videoconferencing device is always within at least the PFOV of the local participant 503, the remote participant gets the feeling of being a part of the conversation. Therefore, the remote participant does not get the feeling of non-intimacy that he may experience when the videoconferencing device is setup in the manner shown in FIG. 1.

Further, because the display screen, camera, and the microphone are all at a natural conversational distance from the local participants, the local participants do not need to shout to be heard as is typically the case in conventional videoconferencing systems shown in FIG. 1. Furthermore, because the displays are closer to the local participants, the displays can be smaller in size for the same field of view and resolution offered by larger display screens placed at one end of the conference room—resulting in lower cost and power consumption.

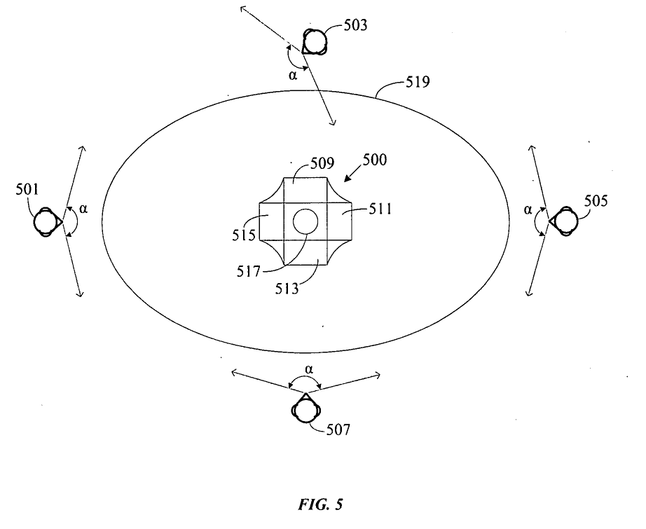

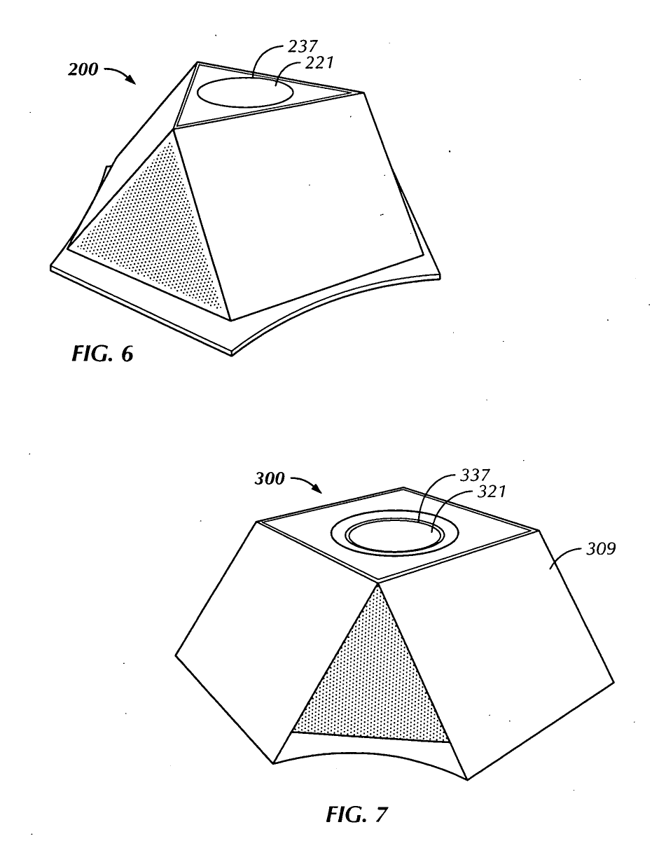

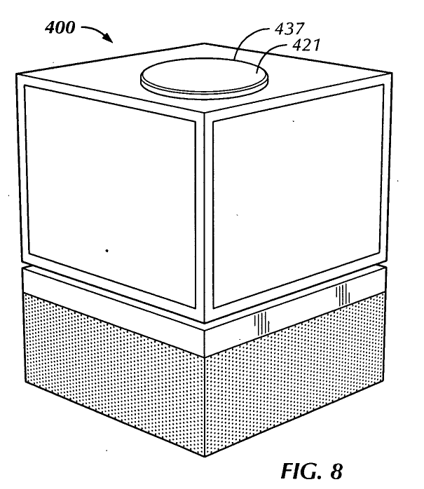

FIGS. 6-8 show the videoconferencing devices of FIGS. 2-4, respectively, with their camera assemblies (221, 321, and 421) retracted into the camera assembly bay (237, 337, and 437). In scenarios where the communication between the local participants and the remote participants is only limited to audio, the visibility of a camera to the local participants may invoke a feeling of lack of privacy. This may occur even though the camera may not be sending images to the remote participants. In other situations, in which the local participants conduct a meeting that does not involve remote participants, the visibility of a camera may again invoke a feeling of lack of privacy. Therefore, for the comfort and peace of mind of the local participants, the embodiment shown in FIG. 7 can retract the camera assembly 321 into the camera bay 337 of the housing 309, when not in use, such that the camera is not visible to the local participants.

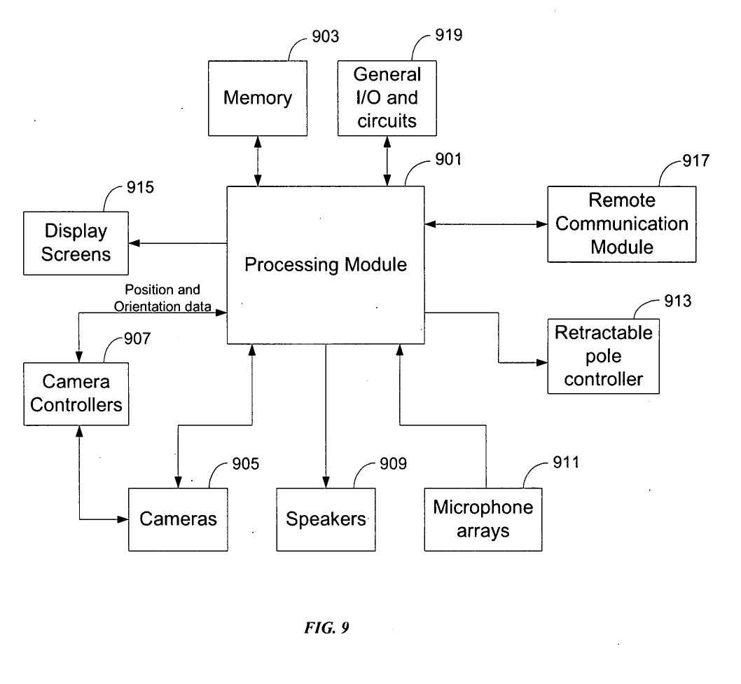

The various embodiments of the videoconferencing devices described herein can have a processing module, hardware, and software to control the operation of the videoconferencing device. As shown in FIG. 9, the processing module 901 can include one or more processors or microcontrollers (e.g., DSP, RISC, CISC, etc.) to control various I/O devices, to process video and audio signals, to communicate with remote location, etc. The processing module 901 can run software that can be stored in the processing module 901 itself, or can be accessed from the memory 903. The memory 903 may include RAM, EEPROM, flash memory, hard-disk drive, etc. The processing module can be enclosed in the housing (e.g., 203, 309, and 401 in FIGS. 2-4, respectively) of the videoconferencing device. The processing module 901 can control the operation of the cameras 905 (e.g., 223-229 in FIG. 2) via camera controllers 907. The processing module can also directly communicate with the cameras 905 for video I/O. In addition, the processing module 901 can interact with speakers 909 (e.g., 311-317 in FIG. 3), microphone arrays 911, retractable pole controller 913, display screens 915 (e.g., 403-409 in FIG. 4), and the remote communication module 917. Furthermore, the processing module can be adapted to also communicate with various other general I/O and circuits 919 required for the operation of the videoconferencing device. Construction of such a system is generally known in the art, and details are not discussed herein.

The camera assembly (e.g., 221 in FIG. 2) may alternatively include one or more cameras. For example, with the ability to pan, tilt, and zoom only one camera may be employed to capture the images or video of a local participant. If a complete view of the conference room is desired in addition to the focus on a local participant, then more than one camera may be employed. Further, the focal length of the lens on the cameras, which determines the angle of coverage, may determine the number of cameras necessary for a 360 degree view of the conference room. Zooming onto a local participant can be achieved by either optical means or digital means. Optically, the cameras have compound lenses, which are capable of having a range of focal lengths instead of a fixed focal length. The focal length of the lens can be adjusted by the processing module. To zoom onto a subject, the focal length of the lens can be increased until the desired size of the subject's image is obtained. Digitally, the captured image/video can be manipulated such that the portion to be zoomed is cropped and expanded in size to simulate optical zoom. The cropping, expanding, and other image and video manipulations to achieve desired image size can be carried out in the camera itself, or on the processing module, or both.

The microphone arrays can be adapted to detect the voice of a local participant, and produce audio signals representing the voice. The microphone array can include at least two microphones. The audio signals from each microphone can be transmitted to the processing module, which may condition the audio signal for noise and bandwidth. In situations where the videoconferencing device is being operated for communicating both video and audio, the processing module can combine the audio signals and the video signals received from the cameras and transmits the combined signal to the remote participants. On the other hand, if the videoconferencing device is being operated for audio conference only, then the processing module need only transmit the audio signals received via the microphone arrays.

The processing module can use the audio signals from the microphone array(s) to determine the positions of the local participants. The position of a local participant can be computed based upon the voice signals received from that local participant. Position data representing the local participant's position can then be generated. The position data can include, for example, Cartesian coordinates or polar coordinates defining the location of the local participant in one, two, or three dimensions. More details on determining locations of local participants using microphone arrays are disclosed in commonly assigned U.S. Pat. No. 6,922,206 entitled “Videoconferencing system with horizontal and vertical microphone arrays,” by Chu et al., and is hereby incorporated by reference. This position data can be used as a target to which the processing module points the cameras to. The processing module can send the position data using signals/commands to a camera controller, which in turn, controls the orientation of the camera in accordance with the position data. The camera controller can also communicate the current camera preset data including, at least, the current tilt, pan, and zoom angle of the camera to the processing module.

The videoconferencing device can also automatically select video signals from one or more cameras for transmission to the remote location. Referring to FIG. 2, the camera assembly 221 includes four cameras 223-229. The processing module may select one camera for focusing on one local participant (e.g., one who is currently speaking), while one or more of the remaining cameras may capture the view of the other local participants. It may be desired to transmit only the image of the currently speaking participant. For example, camera 223 may be selected to point to one local participant, while cameras 225-229 capture the video of the remaining local participants. The processing module can also detect the number of local participants in the conference room by voice identification and voice verification. The microphone array is used to determine not only the number or different local participants, but also the spatial location or each of the detected local participants.

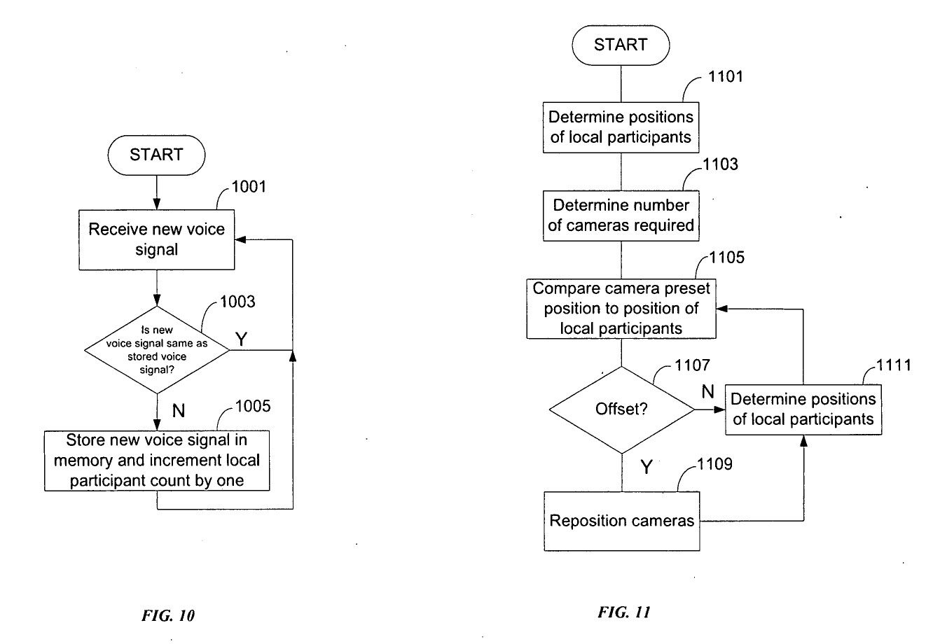

The processing module can include a speech processor that can sample and store a first received voice signal and attributes that voice to a first local participant. A subsequent voice signal is sampled (FIG. 10, Step 1001) and compared (FIG. 10, Step 1003) to the stored first voice signal to determine their similarities and differences. If the voice signals are different, then the received voice signal can be stored and attributed to a second local participant (FIG. 10, Step 1005). Subsequent sampled voices can be similarly compared to the stored voice samples and stored if the speech processor determines that they do not originate from the already detected participants. In this manner, the total number of local participants can be detected.

The processing module can also determine the position of each of the detected local participant. Once the position of each local participant is known, the processing module creates position data associated with each detected local participant (FIG. 11, Step 1101). Once the spatial distribution of the local participants is known, the processing module can determine the number of cameras needed to capture all the local participants (FIG. 11, Step 1103). The position data associated with each participant can be compared with the current position of the cameras (e.g., 223-229 in FIG. 2) to determine an offset (FIG. 11, Steps 1105 and 1107). Using this offset, the new positions for the cameras can be determined. The processing module can then send appropriate signals/commands to the respective camera controller(s) so that the cameras can be oriented to the new positions (FIG. 11, Step 1109). If more than one camera is active, the processing module can combine the video from the multiple cameras such that the multiple views can be displayed on the same screen at the remote participants' location. For example, if all the four cameras 223-229 in FIG. 2 were active, then the processing module combines the video streams from the four cameras such that the video from each camera occupies one quadrant of the display screen. Alternatively, only the image of the current speaker can be sent to the remote site.

The videoconferencing device can automatically detect a monologue and zoom onto the local participant that is the source of the monologue. For example, in situations where there are more than one local participants, but only one local participant talks for a more than a predetermined amount of time, the processing module can control the camera to zoom onto that one local participant (the narrator). The processing module may start a timer for, at least, one voice signal received by the microphone array. If the timed voice signal is not interrupted for a predetermined length of time (e.g., 1 minute), the position data associated with the local participant that is the source of the timed voice signal is accessed from stored memory (alternatively, if the position data is not known a priori, the position data can be determined using the microphone array and then stored in memory). This position data can be compared with the current positions of the cameras. In embodiments with more than one camera, the camera with its current position most proximal to the narrator position data can be selected. The processing module can then transmit appropriate commands to the camera controller such that the selected camera points to the narrator. The processing module may also transmit commands to the controller so as to appropriately zoom the camera onto the narrator. The processing module can also control the camera to track the movement of the narrator. In cases where the videoconferencing device is tracking a narrator during a monologue, the processing module may send the video of the narrator only, or it may combine the video from other cameras such that display area is shared by videos from all cameras.

The videoconferencing device can recognize the face of the local participant in the image captured by the cameras, and can track the motion of the face. The processing module can identify regions or segments in a frame of the video that may contain a face based on detecting pixels which have flesh tone colors. The processing module can then separate out the regions that may belong to stationary background objects having tones similar to flesh tones, leaving an image map with segments that contain the region representing the face of the local participant. These segments can be compared with segments obtained from subsequent frames of the video received from the camera. The comparison gives motion information of the segments representing the face. The processing module can use this information to determine the offset associated with the camera's current preset data. This offset can then be transmitted to the camera controller in order to re-position the camera such that the face appears substantially at the center of the frame. More details on face recognition and tracking and their implementation are disclosed in commonly assigned U.S. Pat. No. 6,593,956 entitled “Locating an audio source,” by Steven L. Potts, et al., and is hereby incorporated by reference. The processing module may use face recognition and tracking in conjunction with voice tracking to provide more stability and accuracy compared to tracking using face recognition and voice alone.

The videoconferencing device can track the motion of the local participant using motion detectors. For example, the videoconferencing device can use electronic motion detectors based on infrared or laser to detect the position and motion associated with a local participant. The processing module can use this information to determine the offset associated with the camera's current present data. The offset can then be transmitted to the camera controller in order to re-position the camera such that the local participant is substantially within the video frame. Alternatively, the processing module can analyze the video signal generated by the camera to detect and follow a moving object (e.g., a speaking local participant) in the image.

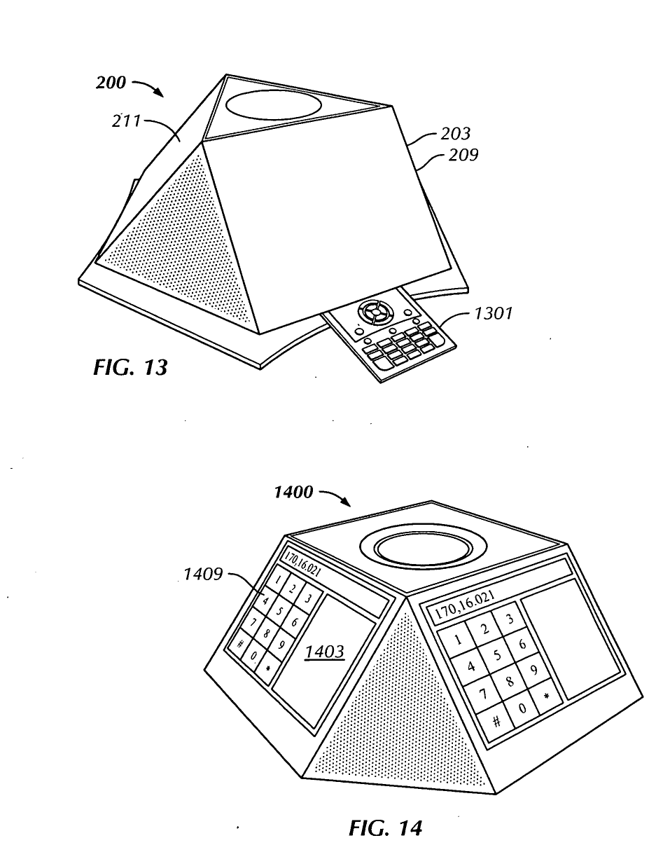

The videoconferencing device can display both video and digital graphics content on the display screens. In a scenario where the remote participant is presenting with the aid of digital graphics, e.g., POWERPOINT®, QUICKTIME® video, etc., the processing module can display both the digital graphics and the video of the remote participant on at least one of the display screens. The remote participant and the graphics content may be displayed in the Picture-in-Picture (PIP) format. Alternatively, depending upon the distribution of the local participants in the conference room, the video of the remote participant and the digital graphics content may be displayed on two separate screens or on a split screen. For example, in FIG. 3, screen 301 and 305 may display the video of the remote participant, while display screens 303 and 307 display the graphics content. The local participants have the option of selecting the manner in which the video and graphics content from the remote site is displayed on the display screens of the videoconferencing device. The user interface (e.g., keypad 1301 in FIG. 13, and the touch screen keypad 1403 in FIG. 14) allows entering desired configuration of the display of media content received from the remote site.

The videoconferencing device can transmit high definition (HD) video to the remote location. The cameras, e.g., 223-229 in FIG. 2, can capture video in either digital or analog form. When analog cameras are employed, an analog-to-digital converter in the processing module can convert the analog video signal into digital form. In either case, the resolution of the video can be set to one of the standard display resolutions (e.g., 1280×720 (720p), 1920×1080 (1080i or 1080p), etc.). The digital video signal can be compressed before being transmitted to the remote location. The processing module can use, but is not limited to, a variety of standard compression algorithms like H.264, H.263, H.261, MPEG-1, MPEG-2, MPEG-4, etc.

The videoconferencing device can receive and display HD video. The videoconferencing device can receive HD digital video data that has been compressed with standard compression algorithms, for example H.264. The processing module can decompress the digital video data to obtain an HD digital video of the remote participants. This HD video can be displayed on the display screens, for example, 301-307 in FIG. 3. The resolution of the displayed video can be 1280×720 (720p), 1920×1080 (1080i or 1080p), etc.

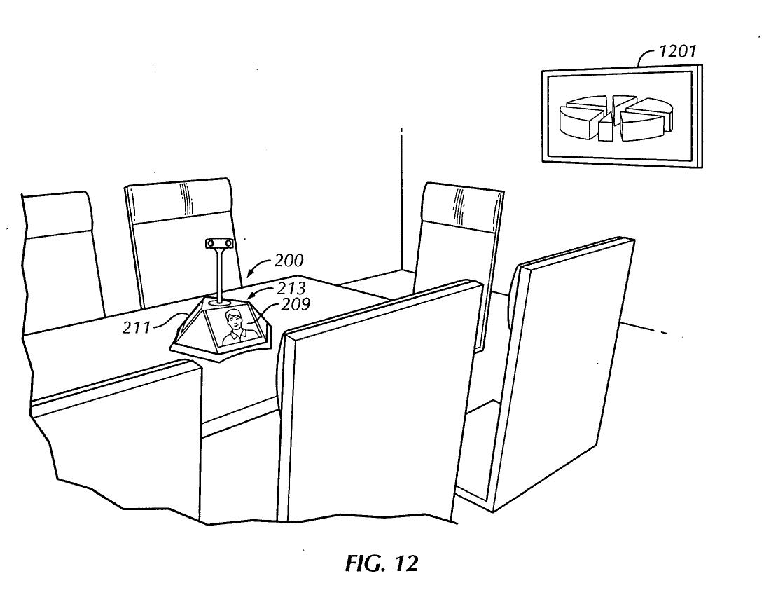

FIG. 12 illustrates the videoconferencing device 200 used in conjunction with a wall mounted content display 1201. In meetings where the participants require transmitting and receiving multimedia content, e.g., slide presentation, video clips, animation, etc., in addition to transmitting the video of the participants, the wall mounted content display 1201 may be used as an auxiliary display. As shown in FIG. 12, the wall mounted content display 1201 can display multimedia content while the display screens 209-213 on the videoconferencing device 200 show the video or images of the remote participants. The multimedia content may be the data displayed on a personal computer or laptop, which is connected to a videoconferencing device at the remote participant's location. The local participants may choose to swap the content displayed on the wall mounted content display 1201 with the content displayed on the display screens 209-213, and vice-versa. The local participants may also choose to combine the content displayed by the wall mounted content display 1201 and display screens 209-213, and display the combined content on all the available display devices. The videoconferencing device 200 can communicate with the wall mounted content display 1201 via wired means or via wireless means. The wired means can be, e.g., computer monitor cables with VGA, HDMI, DVI, component video, etc., while wireless means can be, e.g., RF, BLUETOOTH®, etc.

FIG. 13 shows the videoconferencing device 200 with a keypad 1301. The local participants can use the keypad 1301 to input data and commands to the videoconferencing device 200. Local participants may use the keypad 1301 to initiate and terminate conference calls with remote participants. The keypad 1301 can also be used for accessing and selecting menu options that may be displayed on the display screens 209-213. Although the keypad 1301 is shown attached to the housing 203, the keypad can also be equipped with remote control capability. In this case, the keypad 1301 may be equipped with a transmitter (e.g., infrared, RF, etc.) and the housing 203 may be equipped with an appropriate receiver. The keypad 1301 may also have a port with electrical connectors that removably mates with a complementary port on the housing 203. Therefore, the keypad 1301 may be operated both when it is plugged in to a port on the housing 203, and when it is physically separated from the housing 203.

The display screen of the videoconferencing device can also serve as a touch screen for user input. For example, FIG. 14 shows a videoconferencing device 1400 with display screens 1401 and -1403 with touch screen input. In particular, FIG. 14 shows a touch screen keypad 1409 to enter the IP address of the remote participant's videoconferencing device. The touch-screen keypad 1409 is not limited to the function illustrated in FIG. 14. The processing module may alter the graphic user interface layout on the display screen according to the current operation state of the videoconferencing device. For example, FIG. 14 illustrates the display screens 1401 and 1403 displaying the keypad 1409 to establish a videoconferencing session with remote participants. Once a connection is established, the processing module may display a plurality of virtual buttons that allow the local participant to control various aspects of the ongoing communication, e.g., volume, display screen contrast, camera control, etc. The touch-screen may be implemented based on various technologies, e.g., resistive, surface acoustic wave, capacitive, strain gauge, infrared, optical imaging, acoustic pulse recognition, etc.

The above description is illustrative and not restrictive. Many variations of the invention will become apparent to those skilled in the art upon review of this disclosure. The scope of the invention should therefore be determined not with reference to the above description, but instead with reference to the appended claims along with their full scope of equivalents.

What is claimed is:

1. A group table top videoconferencing device for communication between local participants and one or more remote participants comprising:
a housing comprising:
a top surface,
a bottom surface supporting the housing, and
a plurality of side surfaces extending from the top surface to the bottom surface;
a plurality of display screens disposed on the plurality of side surfaces such that a media content displayed on the plurality of display screens can be viewed from any lateral position around the housing; and
one or more image pickup devices for generating image signals representative of one or more local participants,
wherein the housing is adapted to be positioned such that the housing is within a field of view of every local participant viewing any other local participant.

2. The device of claim 1, wherein the one or more image pickup devices are concealed from the local participant when not in use.

3. The device of claim 1, further comprising:
a plurality of audio pickup devices for generating audio signals representative of sound from one or more local participants; and
a processing module adapted to processing the audio signals received from the plurality of audio pickup devices and determining position data associated with each local participant.

4. The device of claim 3, further comprising:
a controller for controlling pan, tilt, and zoom of each of the one or more image pickup devices, and transmitting preset data associated with each of the one or more image pickup devices to the processing module,
wherein the processing module transmits signals to the controller to adjust the pan, tilt, and zoom of at least one of the one or more image pick up devices based on a result of a comparison of the position data associated with each local participant to the preset data associated with each of the one or more image pickup devices.

5. The device of claim 4, wherein the processing module is adapted to determining a total number of local participants.

6. The device of claim 5, wherein the processing module is adapted to detect a monologue and a position data associated with the local participant that is the source of the monologue and track a movement of the local participant that is the source of the monologue with the one or more image pickup devices such that the local participant is within an image frame generated by the one or more image pickup devices.

7. The device of claim 6, wherein the movement of the local participant is tracked based on the audio signals received from the plurality of audio pickup devices.

8. The device of claim 6, wherein the movement of the local participant is tracked based on face recognition from the image signals generated by the one or more image pickup devices.

9. The device of claim 6, wherein the movement of the local participant is tracked based on combining the audio signals received from the plurality of audio pickup devices and the face recognition from the image signals generated by the one or more image pickup devices.

10. The device of claim 1, further comprising a wall mounted content display for displaying media content received from the remote participants.

11. The device of claim 1, wherein the plurality of display screens are adapted to provide a touch screen for receiving an input from the local participants to control an operation of the videoconferencing device.

12. A method for conducting a videoconferencing communication between local participants and one or more remote participant comprising:
receiving image signals representative of one or more local participants from one or more image pickup devices; and
displaying media content received from the one or more remote participants on a plurality of display screens disposed on a housing such that media content displayed on the plurality of display screens can be viewed from any lateral position around the housing.

13. The method of claim 12, further comprising:
determining the number of local participants.

14. The method of claim 12, further comprising:
determining position data associated with each local participant.

15. The method of claim 14, further comprising:
detecting a monologue by one local participant and tracking the movement of the local participant.

16. The method of claim 13, wherein the determining the number of local participants comprises:
receiving audio signals representing voice signals of the local participants from a plurality of audio pickup devices;
processing the audio signals to determine number of separate voice signals; and
determining the number or local participants based on the number of separate voice signals.

17. The method of claim 14, wherein determining the position data further comprises:
receiving audio signals representing voice signals of the local participants from a plurality of audio pickup devices;
processing the audio signals to determine number of separate voice signals;
determining a spatial position of a source of each voice signal; and
storing the spatial position as position data corresponding to each source of voice signals.

18. The method of claim 15, wherein detecting the monologue comprises:
receiving audio signals representing voice signals of the local participants from a plurality of audio pickup devices;
processing the audio signals to associate each audio signal with each local participant;
timing a first received audio signal until interrupted by a second received audio signal; and
attributing the first audio signal as the monologue if the timing of the first received audio signal is greater than a predetermined threshold value.

19. The method of claim 15, wherein the tracking comprises:
continuously acquiring position data associated with each local participant;
continuously acquiring preset data associated with each of the one or more image pickup devices;
comparing the acquired position data to the acquired preset data of the one or more image pickup devices; and
changing an orientation of the at least one of the one or more image pickup devices such that a difference between the position data and the preset data is minimized.

20. The method of claim 12, further comprising:
concealing the one or more image pickup devices from the local participants when the one or more image pickup devices are not in operation.

21. A group table top videoconferencing device for communicating between local participants and one or more remote participants comprising:
a plurality of display means for displaying media content received from the one or more remote participants;
one or more image pickup means for generating image signals representative of one or more local participants; and
sound pickup means for generating audio signals,
housing means for supporting the plurality of display means, the sound pickup means, and the one or more image pickup means,
wherein the plurality of display means are disposed on the housing such that media content displayed on the plurality of display means can be seen from any lateral position around the housing means, and
wherein the housing means is adapted to be positioned such that the housing means is within a field of view of every local participant viewing any other local participant.

22. The device of claim 21, further comprising:
processing means for processing the audio signals generated by the sound pickup means and determining position data associated with each local participant.

23. The device of claim 22, further comprising:
controlling means for controlling pan, tilt, and zoom of each of the one or more image pickup means and transmitting a preset data associated with each of the one or more image pickup means to the processing means,
wherein the processing means transmits signals to the controlling means to adjust pan, tilt, or zoom of at least one of the one or more image pickup means based on a result of a comparison of the position data associated with each local participant to the preset data associated with each of the one or more image pickup means.

24. A group table top videoconferencing device for communication between local participants and one or more remote participants comprising:
a housing comprising:
a top surface,
a bottom surface supporting the housing, and
a plurality of side surfaces extending from the top surface to the bottom surface;
a plurality of display screens disposed on the plurality of side surfaces;
a plurality of speakers disposed on the plurality of side surfaces;
a retractable pole having a first end and a second end;
a camera assembly mounted on a first end of the retractable pole; and
a camera assembly bay disposed on the top surface,
wherein a second end of the retractable pole is attached to the camera bay,
wherein the camera assembly is at least partially enclosed within the camera bay when the retractable pole is completely retracted, and
wherein the camera assembly is vertically extended by extending the retractable pole.

25. The device of claim 24, wherein the top surface is triangular in shape, the bottom surface is hexagonal in shape, and the plurality of side surfaces comprise three triangular and three rectangular side surfaces extending from the hexagonal bottom surface to the triangular top surface.

26. The device of claim 25, wherein the plurality of display screens are disposed on the three rectangular side surfaces, and the plurality of speakers are disposed on the three triangular side surfaces.

27. The device of claim 24, wherein the housing is placed on a conference table such that the housing is within a field of view of every local participant viewing any other local participant.

28. The device of claim 25, wherein the plurality of display screens are disposed on the three rectangular surfaces such that media content displayed on the plurality of display screens can be seen from any position in a horizontal plane around the housing.

29. The device of claim 24, further comprising a plurality of microphones disposed on the camera assembly.

30. The device of claim 24, wherein the top surface is rectangular in shape, the bottom surface is octagonal in shape, and the plurality of side surfaces comprise four triangular and four rectangular side surfaces extending from the octagonal bottom surface to the rectangular top surface.

31. The device of claim 30, wherein the plurality of display screens are disposed on the four rectangular side surfaces, and the plurality of speakers are disposed on the plurality of triangular side surfaces.
